(19) United States
(12) Patent Application Publication
(10) Pub. No.: US 2007/0036299 A1
(43) Pub. Date: Feb. 15, 2007

(54) Software based reminder service

(76) Inventors: Douglas G. Marsh, Bethlehem, PA (US); Apparajan Ganesan, Colorado City, TX (US)

Correspondence Address: Douglas G. Marsh, 1031 Graham St, Bethlehem, PA, 18015, US

(21) Appl. No.: 11/184,246

(22) Filed: Jul. 20, 2005

(51) Int. Cl. H04M 1/64

(52) U.S. Cl. 379/88.22; 348/717

(57) ABSTRACT

In accordance with the present invention, a reminder service is disclosed that uses computer-like means to store information regarding the action being reminded. The service allows either the service provider or the end user to define the relevant information, that is, the what of the reminder, the when to do the reminding, the how and where to transmit the reminder, and the form of the reminder.

### CROSS-REFERENCE TO RELATED APPLICATIONS

Not applicable.

### BACKGROUND

1. Field of Invention

This invention relates to means for automatically sending reminders to various personal electronics instruments using various communications means such as the Internet or cell phone.

2. Description of Prior Art

The situations in which individuals or groups can benefit from automatic reminders are countless. For example, a dentist typically has his or her receptionist monitor the patient calendar and place a call to the patient a few days before the next examination to remind the patient of the appointment. A person on business typically dials the front desk for a wake up call. An individual with a prescription typically relies on keeping an eye on the number of pills to decide when to call for a refill, and a timely reminder to take the prescription might also be of value, especially for the elderly who often suffer from short term memory loss.

Present methods for dealing with these rely on human action and errors are common, especially forgetting to send the message or failing to receive the message either at all or at an appropriate time.

U.S. Pat. Nos. 6,784,899, 6,760,412, 6,182,041, 6,014,429 and 5,982,856 and U.S. Published Patent Applications 20040156486, 20030120757 and 20020165751 address reminder services:

U.S. Pat. No. 6,784,899 deals with providing the message, not with the issues of timing its delivery and the medium of transmission, and it is specifically directed toward telephone and facsimile communication.

U.S. Pat. No. 6,760,412 discloses a scheduler that is primarily concerned with sending messages over the telephone network and does not allow for message transmission until successful connection.

U.S. Pat. No. 6,182,041 discloses a system intended to have messages received as voice. It does not suggest that the originator of the message have discretion as to the format of the received message.

U.S. Pat. No. 6,014,429 is a pager based messaging system.

U.S. Pat. No. 5,982,856 deals with a message network, not with the issues of timing the message or of the wide variation of hardware to which a sender may want the message sent.

No. 20040156486 discloses a means of providing remote reminders and scheduling reception of a data record only through the telephone.

No. 20030120757 is directed toward sending fragments of a reminder between two fixed terminals in a distributed network.

No. 20020165751 deals with point-to-point reminder service and is directed toward programmable terminal equipment.

### SUMMARY

In accordance with the present invention, a computer program based reminder service is located at a web site or in computer-like hardware such as a personal computer, cell or other smart-type phones. A reminder originator, i.e., a service provider or other person wanting to send a reminder could have control of the program, or the person receiving a self-reminder could have control. A general user interface allows relevant details such as the name of the reminder receiver, the type, time and date(s) of sending the reminder, and relevant contact information to be entered. The message itself may be entered in a variety of formats, including text, voice, video, picture, music, etc. limited only by the storage, transmission, and reception capabilities and by the ingenuity of the service provider and the target market of that provider. At a time also input by the controlling person, the system begins to attempt to contact the end recipient, and this continues, also according to input information, which can include a hierarchical search for success. Various services are likely to have different data bases.

### OBJECTS AND ADVANTAGES

Accordingly, several objects and advantages of this invention are:
(a) Service providers can automatically remind customers of the next service.
(b) Individuals can identify various actions in their own lives about which they want a reminder.
(c) Such reminders are automatic and continue at predefined times until some pre-defined limit or until the reminder is successfully received.
(d) The software can reside at a web site, in a personal computer, in a cell phone, or in almost any other computer-like hardware.
(e) Reminders can be in the form of text messages, voice messages, mailed paper, pictures, video, or other electronically storable formats.
(f) The message originator can be notified that the message has been sent or received or both.
(g) The reminder service can automatically switch through a defined hierarchy of recipient terminal equipment and the data format of the message can be changed as the service traverses through that hierarchy.
(h) The reminder service can be low cost and available to the general public because it can reside on a web server, in a personal computer, or in a cell or other smart phone.

### DRAWING FIGURES

FIG. 1. Block diagram of the elements of the reminder message system.

FIG. 2. Example of a hierarchy of messages.

### DESCRIPTION—PREFERRED EMBODIMENT

In accordance with the present invention, a reminder service is disclosed that uses computer-like means to store information regarding the action being reminded. The service allows a reminder originator, i.e., a service provider, someone wanting to send a reminder, or the end user to define the relevant information, that is, the “what” of the reminder, the “when” to do the reminding, the “how and where” to transmit the reminder, and the form of the reminder.

The invention being disclosed is not a single computer program. Among the reasons is that varying memory requirements make a single program inefficient. For example, a program residing on a web server might be quite general in order to serve a wide variety of different application. On the other hand, software resident on a cell phone, where price issues are often key to the sale of the cell phone, would likely be much less flexible. A program resident on a personal computer, such as in a medical office, might be structured for a specific application, but might have a large data base and a variety of delivery formats, for example, telephone, e-mail, hard copy mail, etc. The exact form of each application package would be driven by developers cognizant of the application.

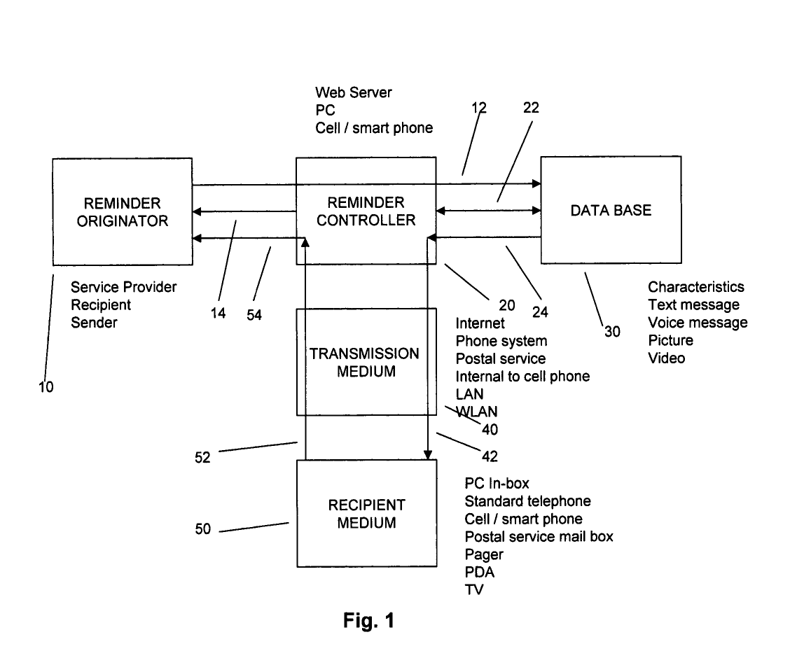

Referring to FIG. 1, the basic elements of the reminder service are shown. Following are examples of the various components in the system. Implementers of reminder services will find countless more.

While many existing means of similar messaging exist, they are not readily available to the general public, they generally lack the structure allowing the message to be sent regularly or semi-regularly, they lack the ability to be delivered at a specific time, or they lack the ability to deliver in various different forms (they might be e-mail only or voice phone call only).

There is a reminder originator 10. This can be the service provider (doctor, dentist, home heating and air conditioning service company, swimming pool cleaning service, etc.) or the end user (a woman wanting to remind herself to order a medical prescription each month, to take pills at dinner, to pick up a daughter at girl scouts every Thursday, to arrange for the new puppy's first trip to the vet [subsequent trips could be “reminded” by the vet], etc.). A third category would be someone who wants a reminder message not “service” related delivered to someone else. For example, Mom or Dad could enter a reminder for someone else in the family (remind elder daughter via cell phone at 3:30 pm every second Tuesday to pick up younger son at school that day at 4:30 pm after his monthly art club meeting). Or a wife on a business trip could send a message to her husband to feed the dog via a video clip or photo of their dog eating its chow. It is preferable, but not necessary, that the originator 10 and the recipient agree ahead of time on the how the message will be received, i.e. the recipient medium 50.

The reminder originator 10 accesses the reminder controller 20. In one preferred embodiment, the reminder controller 20 is resident at a web site. The reminder originator 10 simply logs into that web site. In another embodiment, the controller 20 resides on the PC belonging to the provider 10, and the provider 10 simple clicks to that program. In yet another embodiment, the controller 20 resides on a cell or smart phone used by the originator 10, and the originator 10 simply finds the program on the phone's menu. Any other computer-like electronics on which the controller 20 can reside may be used, and the controller 20 is accessed by whatever means is allowed. The reminder controller 20 is the program that controls the reminder service. Its main features are that (1) it can access the data base 30 to allow entering 12 information, (2) it monitors 22 the data base 30 to determine when, where, and how the reminder should be sent 30, (3) it accesses 24 the message at the appropriate time, and (4) it sends 32 the reminder.

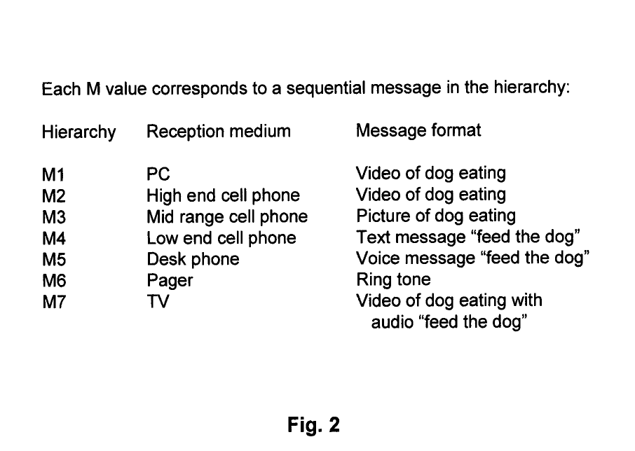

In today's environment, text based entry of most of the information would be the most pervasive an error free method. However, as voice recognition improves, in the near future, voice entry will also become quite practical. Also, with the rapid proliferation of PC camcorders, digital cameras, digital video recorders, and cell phones having photo and video capability, it has already become trivial to send pictures and video. So in a web server, PC, cell or smart phone based environment, the controller 20 builds a screen that typically would be structured with boxes for data entry. Obviously, the screen on the web or PC based system can be more complex than the small phone screen. Here, the person entering the information can indicate to whom and when it should be delivered, where/how (e-mail or postal service mail address or phone number) it should be delivered, the format/instantiation of the message, how often attempts to deliver should be made (if the message is going to a phone), and a hierarchy of what terminal equipment terminal to contact and the associated message format. One example of a hierarchy of a “feed the dog” message is shown in FIG. 2. Those skilled in the art will understand immediately that some protocol would be useful to determine if a message is received before moving down the hierarchy. In the case of a phone, no answer is such a protocol; in the case of a PC, a wait time for an e-mail response would suffice. However, lack of a full protocol would not necessarily stop the hierarchy: the sender could specify that lack of any formal reception message automatically sends the message to the next level (under no circumstances should the dog go unfed!). Such choices may be determined by the service provider, the message originator, and the message recipient.

The originator 10 can specify if the message is repetitive, and if so, at what repetition rate (e.g., monthly). Simple programs might have difficulty with “second Tuesday” but more powerful ones would only need to have the questions well structured for such flexibility. All of this information is transferred 12 to the data base 30. Of course, the message itself also needs to be stored. Here, voice recognition is not important, so text messages or voice messages are both reasonable today with readily available, low cost technology. All that is needed for a voice message is for the system to have voice/data conversion capability and/or sufficient memory, all of which are commonly available.

When the reminder controller 20 monitoring the data base 30 determines that a reminder is to be sent, the controller 20 accesses the appropriate transmission medium 40 and the end address. If the address is an e-mail address, then the message is accessed 24 and simply e-mailed out over the Internet or phone system, and this would be either in text form or in a voice stream form (the reminder originator 10 would, of course, have to know what form the end user can/is willing to accept the message. Telephones not equipped with a screen for messaging would need a voice message. Most cell phones have screen message capability, so either text or voice messages are acceptable, and most U.S. cell phone companies already offer voice messaging at little of no extra cost. When the message is sent to an end user who does not have (or is not known by the reminder originator 10 to have) a phone answering machine capability, then the reminder originator 10 would want the message repeated sent at some interval for some time. The lowest level of technology that might be used for transmission 40, 42 is a hard copy of the reminder printed out and sent through the postal service. Automatic means for generating post cards of this type already exist; messages in envelopes require somewhat more hardware or more human intervention, but those skilled in the art can clearly understand the issues and solutions. Voice over Internet Protocol (Voice over IP or VoIP) allows a web server user or PC user to easily send messages over the Internet to a PC, to a TV via means such as cable or digital satellite system, or onto a public switched telephone network (PSTN). The alternatives are countless and change daily as technology evolves.

Nothing prohibits the originator 10 from sending a reminder to him or her self. In this case, if the cell phone is used for both the controller 20 and the data base 30, the transmission medium 40 is completely inside the cell phone. No phone call is needed. The cell phone simply rings itself and gives the originator/recipient the message

The recipient 50 of the reminder might get the message as in e-mail, as a telephone call, as a telephone message left when the phone was not answered, or as a hard copy mail. There is no guarantee that the end user will properly respond to the message, of course, but solving that is beyond the scope of this invention. However, if the message is in the form of an e-mail, the provided can be notified 14 by the controller 20 that the message has been sent. Also the recipient 50 can be asked to send a reply 52 that the message has been received and either will or will not be acted upon. Such a response 52 can be automatically routed 54 by the reminder controller 20 to the reminder originator 10.

Throughout this description, referenced to various specific forms of the originator 10, controller 20, data base 30, transmission medium 40, and recipient have been made. It will be clear to those skilled in the art that these are only intended as examples, and any number of other means, current existing or developed at a later time can fit into the overall structure disclosed by this invention.

Those skilled in the art will immediately recognize that the reminder service disclosed here can be low cost and available to the general public because it can reside on a web server, in a personal computer, or in a cell or other smart phone, and the message can be stored in various formats as best suits the reminder originator, including originators having nothing more than access to a world wide web via an Internet cafe.

### ADVANTAGES

From the description above, a number of advantages of this method of a software based automatic reminder service are apparent:
(a) Service providers can automatically remind customers of the next service.
(b) Individuals can identify various actions in their own lives about which they want a reminder.
(c) Such reminders are automatic and continue at predefined times until some pre-defined limit or until the reminder is successfully received.
(d) The software can reside on a web site, on a personal computer, in a cell phone, or on almost any other computer-like hardware.
(e) Reminders can be in the form of text messages, voice messages, mailed paper, pictures, video, or other electronically storable formats.
(f) The message originator can be notified that the message has been sent or received or both.
(g) The reminder service can automatically switch through a defined hierarchy of recipient terminal equipment and the data format of the message can be changed as the service traverses through that hierarchy.
(h) The reminder service can be low cost and available to the general public because it can reside on a web server, in a personal computer, or in a cell or other smart phone.

### CONCLUSIONS, RAMIFICATIONS, AND SCOPE

Accordingly, it is evident that this invention discloses a means for using a computer program located in an Internet server or on almost any other electronic instrument having computer-like capability to send a message to people, including oneself, regarding virtually anything, from any type of terminal equipment, in any form and in any hierarchy as defined by the service provider or other message originator.

We claim:

1. A means of generating an automatic reminder message by a system composed of a reminder controller, a data base, a transmission medium, and a recipient medium;
said controller is the interface between the message originator and the rest of said system;
said message originator who is a person wanting to generate said reminder;
said data base is a memory storage medium wherein the relevant characteristics of said message are stored and wherein said message is stored;
said transmission medium is the means by which said controller sends said message; and
said recipient medium is the means through which the recipient of said message receives said message.

2. An automatic reminder message system according to claim 1 wherein said controller software can reside in any computer-like electronic apparatus including a web server, a personal computer, and a cell phone.

3. An automatic reminder message system according to claim 1 wherein said memory storage system is of an appropriate size for the number of said messages, the characteristics of said message, and the text, voice, image, or sound nature of said messages for the particular application of any implementation of said system.

4. An automatic reminder message system according to claim 1 wherein said transmission medium could be any medium appropriate for said message that said recipient will accept such as text capable or voice only phone, e-mail, hard copy mail, PC, TV, etc.

5. An automatic reminder message system according to claim 1 wherein said means through which the recipient of said message receives said message could be text, image, or sound capable terminal equipment including but not limited to a PC, a TV or a cell phone, a voice only phone, or hard copy mail.

6. An automatic reminder message system according to claim 1 wherein a response that said message has been sent can be automatically sent from said controller to said message originator.

7. An automatic reminder message system according to claim 1 wherein a response that said message has been received can be generated by said recipient and returned to said originator.

8. An automatic reminder message system according to claim 1 that can traverse through said transmission media and said recipient media selecting and sending said message from said storage that is compatible with each said transmission media and said recipient media until said controller determines that said message has been successfully received by said recipient media or until said controller determines that said message should no longer be sent.
